(19) United States
(12) Patent Application Publication
(10) Pub. No.: US 2009/0210151 A1
(43) Pub. Date: Aug. 20, 2009

(54) INFORMATION GENERATION SYSTEM AND INFORMATION GENERATION METHOD

(75) Inventor: Shunsaku Toyoda, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Meguro=ku Tokyo (JP)

(21) Appl. No.: 12/294,097

(22) PCT Filed: Feb. 21, 2007
(86) PCT No.: PCT/JP2007/053199

§ 371 Date: Sep. 23, 2008

(30) Foreign Application Priority Data
Mar. 24, 2006 (JP) 2006 083107

(51) Int. Cl. G01C 21/26

(52) U.S. Cl. 701/208

(57) ABSTRACT

There is provided an information generation system, an information generation method and so on that generate information to correlate a road image to a branch point and that are capable of clearly recognizing heading direction or the like at the branch point while reducing work for correlating the branch point and image of a road at the branch point and cost required for creating the image.

A system control unit 11 identifies an incoming link and an outgoing link at a branch point based on network data including lane connection information, creates a branch point flag indicative of existence of an incoming lane line corresponding to a branch between two adjacent outgoing roads based on lane connection information between the incoming link and the two adjacent outgoing links, creates an incoming lane flag indicative of correspondence relation between the incoming lane line and the outgoing lane line based on the lane connection information between the incoming link and respective outgoing links, and creates a road pattern including the branch point flag and the incoming lane flag.

### BACKGROUND OF THE INVENTION

1. Field of the Invention

The present invention belongs to the field of an information generation system and an information generation method that associate an image with a branch point in order to display the image at the branch point of the road in a navigation system for guiding a vehicle route or the like.

2. Discussion of Related Art

In a navigation system for vehicle route guidance, conventionally there has been generally used a method of displaying an illustration image of a road at a branch point on the screen and displaying a travel direction by an arrow mark or the like, as a method of guiding a travel direction or the like at the branch point when a vehicle approaches the branch point of the road.

In such a guiding method, it is essential to prepare an illustration image where characteristics of the road are clearly expressed in respective branch points in order to clearly recognize a travel direction or the like at the branch point.

However, correspondence between respective branch points and illustration images at the time of map data creation is, for example, manipulated by an operator by hand one point by one point while referring to an actual image screen or the like of the branch point, or illustration image is also created by an operator while referring to the image screen or the like.

Therefore, the cost required for these operations becomes large. Further, the branch numbers, the road shapes, and the lane numbers differ from each other in respective branch points. In consideration of the above, if it is tried to previously make illustration images corresponding to all patterns, these increases load of making illustration images and an efficiency of working is deteriorated.

Meanwhile, when the vehicle route is actually guided in the navigation system, a method of creating images or the like of the roads corresponding to branch points and displaying the images is proposed.

For example, Patent Document 1 discloses a method that an image pattern for universal branch point guidance is previously stored, an image pattern is synthesized based on a relation of connection between the incoming road and the outgoing road and the number of lanes, and a schematic diagram of the branch is created.

Further, Patent Document 2 discloses a method of creating a branch pattern based on the lane number immediately after a junction or lane number decrease, in a case where the junction or the lane number decrease exists between the vehicle position and the branch point.

### Patent Document 1: Japanese Unexamined Patent Publication No. 2001-74490

Patent Document 2: Japanese Unexamined Patent Publication No. H11-94582

### SUMMARY OF THE INVENTION

However, according to the method of Patent Document 1, one image pattern corresponds to one branch. Therefore, it is difficult to say that only universal image patterns can express all characteristics of the actual branch points.

Further, according to the method of Patent Document 2, when the branch diagram is created, only road information before the branch is considered but the road after the branch is not considered. Therefore, it cannot say that the branch diagram appropriately expresses characteristics of the road at the branch point.

Accordingly, it is difficult that the method of creating illustration image at the time of route guidance appropriately expresses the road at the branch point.

The present invention is provided in view of the above points. An example of the object is to provide an information generation system and an information generation method that generate information for relating a road image to a branch point so that a travel direction or the like at the branch point can be clearly recognized, whereas the cost required for the work for relating a branch point and road image at the branch point and creation of the image is reduced.

In order to solve the above object, according to one aspect of the present invention, there is provided an information generation system that generates road pattern data indicative of a road pattern at the branch point, based on road data, for identifying a road image expressing a road at the branch point, wherein the road data include lane connection information between roads connected at the branch point, the information generation system including:

a road identification means for identifying one incoming road and a plurality of outgoing roads at the branch point based on the road data;

a borderline existence information generation means for generating borderline existence information indicating whether or not the borderline defining respective lanes of the incoming road exists in correspondence with a branch between two outgoing roads adjacent to each other, based on the lane connection information between the identified incoming road and two adjacent outgoing roads;

a borderline correspondence information generation means for generating borderline correspondence information that indicates a correspondence relation between the borderline defining respective lanes of the incoming road and the borderline defining respective lanes of the respective outgoing roads, based on the lane connection information between the incoming road thus identified and respective outgoing roads; and

a road pattern generation means for generating the road pattern data consisting of the borderline existence information and the borderline correspondence information that are thus generated, at the branch point.

According to another aspect of the present invention, the computer is caused to function as the information generation system.

According to another aspect of the present invention, there is provided an information generation method of generating road pattern data indicative of a road pattern at a branch point based on road data for identifying a road image expressing a road at the branch point, wherein the road data that include lane connection information between roads connected at the branch point, comprises:

a step of identifying one incoming road and a plurality of outgoing roads at the branch point based on the road data;

a step of generating borderline existence information indicating whether or not a borderline defining respective lanes of the incoming road exists in correspondence with a branch between two outgoing roads adjacent to each other, based on the lane connection information between the identified incoming road and two adjacent outgoing roads;

a step of generating borderline correspondence information that indicates a correspondence relation between a borderline defining respective lanes of the incoming road and a borderline defining respective lanes of the respective outgoing roads, based on the lane connection information between the incoming roads thus identified and respective outgoing roads; and

a step of generating the road pattern data consisting of the borderline existence information and the borderline correspondence information thus generated, at the branch point.

### BRIEF DESCRIPTION OF THE DRAWINGS

FIG. 1 is a view showing an example of a schematic configuration of a data creation system S related to the present embodiment.

FIG. 2 is a view showing an example of a branch illustration related to the present embodiment.

FIG. 3 is a view showing an example of a branch illustration related to the present embodiment.

FIG. 4(a) is a view showing an example of a combination of branches, and (b) is a view showing an example of an assignment of branch illustration for multistage branches.

FIG. 5 is a view showing an example of one record configuration in an illustration pattern table or the like.

FIG. 6 is a view showing an example of one record configuration in an illustration pattern table or the like.

FIG. 7 is a view showing an example of one record configuration in an illustration pattern table or the like.

FIG. 8 is a view showing an example of assignment condition of an arrow mark ID, wherein (a) is a case of a single-stage branch and (b) is a case of a multistage branch.

FIG. 9 is a view showing an example of an assignment of the arrow mark ID, and (a) is a case of single-stage two branches, (b) is a case of single-stage three branches, and (c) and (d) are cases of multistage branches.

FIG. 10(a) is a view showing an example of setting condition of a branch point flag, and (b) and (c) are views showing a setting example of a branch point flag.

FIG. 11 is a view showing an example of setting conditions of the main road flag.

FIG. 12 is a view showing an example of a shape ID and an image of a corresponding road shape in the illustration.

FIG. 13(a) is a view showing an example of an acquisition image of angle alignment, (b) is an example of computing equation of judgment angle for assigning a shape ID based on the angle alignment.

FIG. 14 is a view showing an example of setting condition of the shape ID.

FIG. 15 is a view showing an example of an adjustment image of the lane number in a single-stage branch. (a) is an actual road, and (b) is a branch illustration after adjusting the lane number.

FIG. 16 is view showing an example of the lane number adjustment image in the multistage branch.

FIG. 17 is a view showing an example of setting condition of an incoming lane flag.

FIG. 18 is a view showing a setting example of the incoming lane flag.

FIG. 19 is a flowchart showing a processing example of a system control unit 11 of the data creation system S related to the present embodiment.

FIG. 20 is a flowchart showing an example of a single-stage branch process of the system control unit 11 in the data creation system S related to the present embodiment.

FIG. 21 is a flowchart showing an example of a multistage branch process of the system control unit 11 of the data creation system S related to the present embodiment.

FIG. 22 is a flowchart showing a process example of the system control unit 11 of the data creation system S related to the present embodiment.

FIG. 23 is a flowchart showing an example of single-stage branch process of the system control unit 11 of the data creation system S related to the present embodiment.

FIG. 24 is a flowchart showing an example of a multistage branch process of the system control unit 11 of the data creation system S according to the present embodiment.

FIG. 25 is a flowchart showing an example of difference process of the system control unit 11 of the data creation system S related to the present embodiment.

### DESCRIPTION OF THE PREFERRED EMBODIMENTS

Hereinafter, each designation of numerical reference in the drawings is typically as follows:
11 System control unit;
12 Memory unit;
13 Optical disc drive;
14 Display unit;
15 Operation unit;
16 Communication unit; and
S Data creation system

### THE BEST MODE FOR CARRYING OUT THE CLAIMED INVENTION

Hereinafter, embodiments of the present invention will be described in reference of drawings. Here, in the embodiments explained below, the present invention is applied to a data creation system that creates data for determining illustration to be created while relating respective branch points to illustration for guiding a travel direction at the branch point of the road in navigation system.

### [1. Configuration, Function and the Like of Data Creation System]

First, configuration and function of the data creation system S related to the present embodiment.

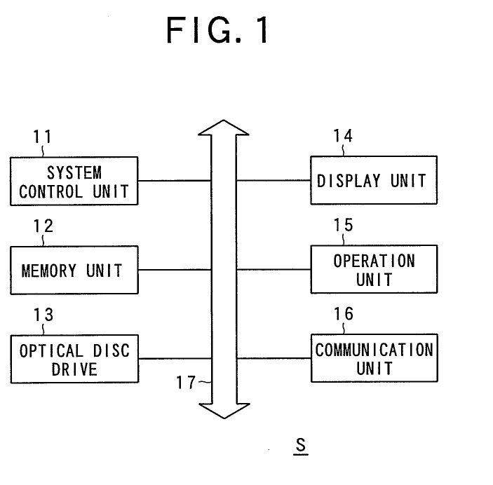

FIG. 1 is a view showing an example of a schematic configuration of a data creation system S related to the present embodiment.

As shown in FIG. 1, the data creation system S includes a system control unit 11 that includes CPU (Central Processing Unit), RAM (Random Access Memory), ROM (Read Only Memory), or the like; a memory unit 12 (e.g. hard disc drive) that memorizes various programs, data or the like; an optical disc drive 13 that reads out data from an optical disc such as CD (Compact Disc) and DVD (Digital Versatile Disc) and records the data to an optical disc that is recordable and writable; a display unit 14 (e.g. CRT (Cathode Ray Tube) display, crystal liquid display) that displays information such as characters and images; an operation unit 15 (e.g. keyboard, mouse) that receives an operation instruction from the user and outputs content of the instruction to the system control unit 11 as an instruction signal; and a communication unit 16 that connects to a network such as LAN (Local Area Network) and controls communication status with other computers. The control unit 11 and respective units are mutually connected through a system bus 17.

Here, the system control unit 11 forms up an example of a road identification means, a borderline existence information generation means, a borderline correspondence information generation means, a road pattern generation means, a shape pattern generation means, a lane number information generation means, a judgment means, a road pattern list generation means, an image identification means, a branch point pattern list generation means, and a difference pattern list generation means.

As a data creation system S, for example, a personal computer, a workstation or the like can be applied.

The system control unit 11 reads out various programs (information generation process program or the like) memorized by ROM and a memory unit 12 to control the entire data creation system S and to function as the respective means mentioned above.

For example, the system control unit 11 causes the memory unit 12 to memorize the road network data forming map data in a given area through the optical disc drive 13 and the communication unit 16. Such the network is read out, and an illustration pattern table, an entire assignment list, a difference pattern list or the like described later are generated and memorized in the memory unit 12.

Here, the network data (an example of road data) include such as road shape of respective roads, lane number, and lane connection information between respective roads at a branch point in a given area. Specifically, the network data includes, for example, lat/long information of node indicative of a branch point on the road, a road condition change point or the like and an interpolation point of the link connected to the node, and information of connecting each of the lanes in the link to which lane inside the other links. Such the network data may be supplied by those built in map data used for the existing navigation system or the like. The network may also use those which are created based on field research.

Here, the various programs may be recorded, for example, by a recording medium such as CD-ROM and read in through the optical disc drive 13, or may be downloaded from the predetermined server through the communication unit 16.

### [2. Branch Illustration]

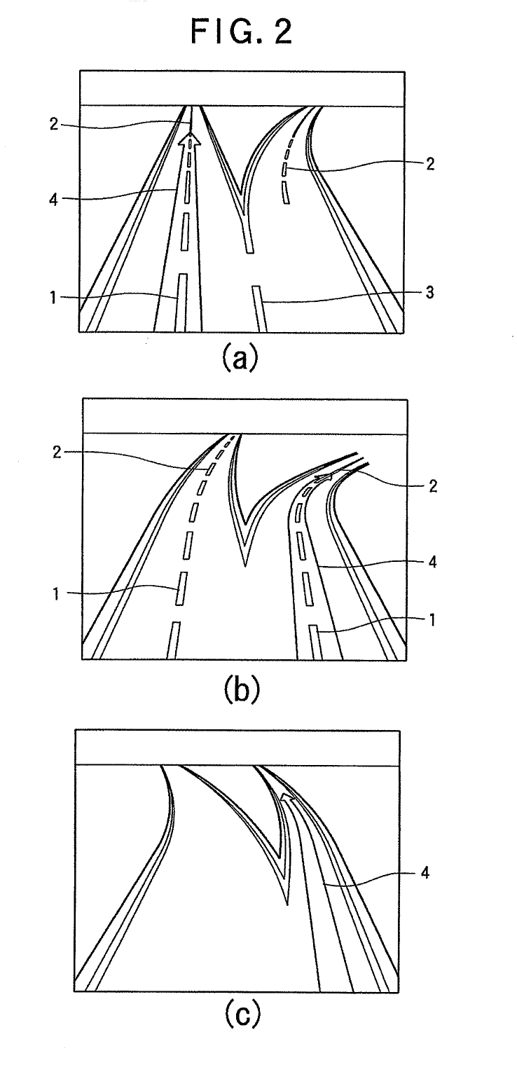

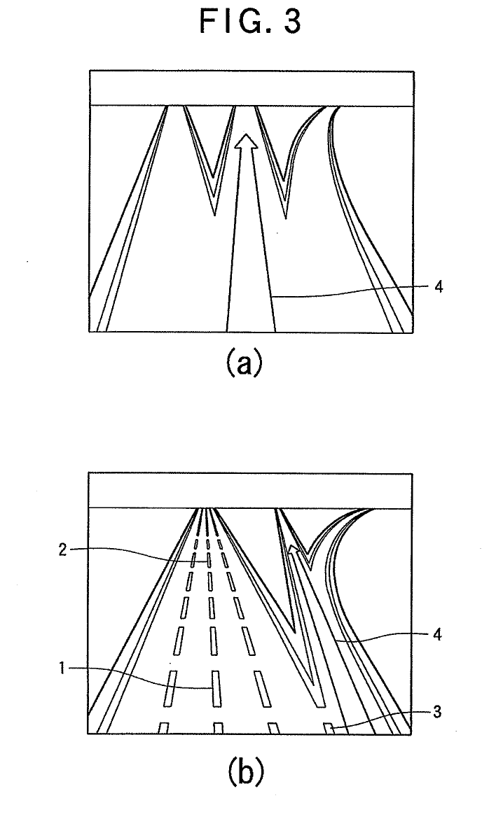

Next, a branch illustration (an example of road image) displayed on the screen in the navigation system of the present embodiment is described with reference to FIGS. 2 and 3.

FIGS. 2 and 3 are views showing examples of branch illustration related to the present embodiment.

The branch illustration is an illustration that indicates an overall diagram of the road at a branch point of the road (branch point of a freeway, a toll road or the like in an example of the present embodiment) and an outgoing direction for a vehicle to travel.

FIG. 2(a) is a first example of a branch illustration showing a single-stage two branches where a road divides into two directions at a branch point. In this figure, one incoming road in front of the branch and two outgoing roads after being branched are illustrated, an incoming lane line 1 (an example of a borderline) is illustrated on the left side of the incoming road and leads to an outgoing lane line 2 (an example of a borderline) of the left outgoing road. This shows it is accessible to two lanes of the left outgoing road from the two left lanes without change. On the other hand, the incoming lane line 1 is not shown on the right side of the incoming road, and it shows that it is accessible to both the two lanes of the right outgoing road. In the incoming road, a lane line 3 (an example of a borderline) corresponding to a branch between the two outgoing roads is illustrated. Further, an arrow mark 4 indicating that a vehicle is to enter the left outgoing road is illustrated. In the present embodiment, such the illustration is prepared every outgoing direction with respect to the same branch point.

FIG. 2(b) is a second example of the branch illustration showing a single-stage two branches. In this figure, lane lines from the incoming road lead to outgoing roads on the right and left sides. At a branch between two outgoing roads, corresponding lane lines are not illustrated. This shows it is accessible (branched) to two outgoing roads from one lane (an example of lanes) of the incoming road. Further, it is illustrated in such a manner that a curve angle of the left outgoing road is different from a curve angle of the right outgoing road. In the present embodiment, the outgoing road is expressed in three shapes of straight, small angle curve, and large angle curve (five shapes in total of right and left roads).

FIG. 2(c) is a third example of the branch illustration showing a single-stage two branches. In this figure, a width of the road to outgo to a left side is larger than that of the road to outgo to the right side. This shows the left outgoing road is a main road, and the right outgoing road is a ramp way. Although the main road often has plural lanes in the actual freeway or the like, there exist points not having the lane information set in the original network data in some cases. Therefore, a width of the main road is illustrated broader in order to conform the illustration of branch to the reality as much as possible. Further, a user of the navigation system (driver, passenger or the like) can easily differentiate the main road from the ramp way by this way.

FIG. 3(a) is an example of an illustration of branch showing a single-stage three branches where a road is divided at one branch point into three directions. In this embodiment, an illustration of branch up to three branches is prepared.

FIG. 3(b) is an example of a branch illustration of multistage branch where a road is divided into two directions at a front branch point, and the road is divided into two directions down the outgoing road. This shows there is a further branch point (second stage) within the predetermined distance from the first branch point (first stage), and the illustration of branch up to the second stage is prepared in the present embodiment.

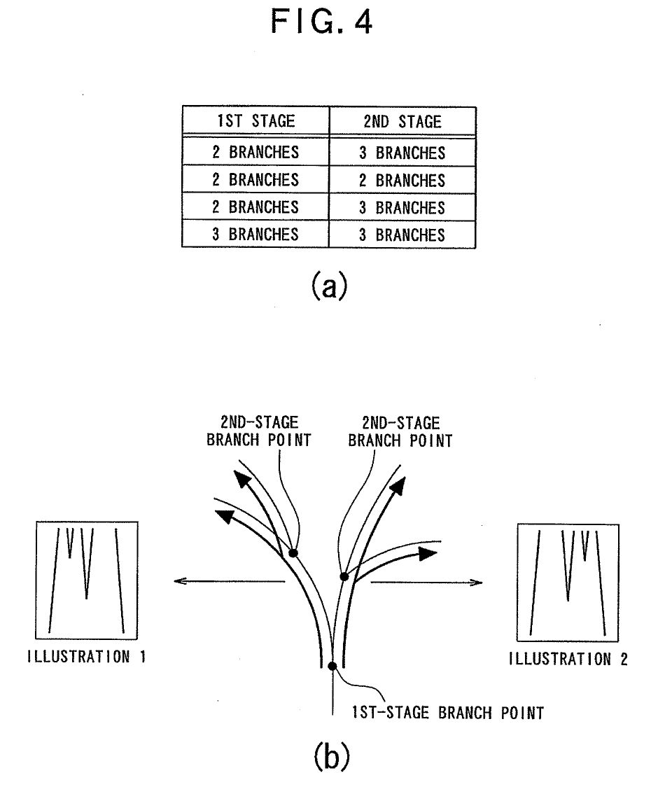

FIG. 4(a) is a view showing an example of combination of branches. FIG. 4(b) is a view showing an example of assignment of branch illustration for multistage branches.

In the present embodiment as shown in FIG. 4(a), there are two branches and three branches at the first stage and there are also two branches and three branches at the second stage. There are four patterns of combination.

Further, in a case where there exist branches at the second stage in plural outgoing roads at the first stage, branch illustrations correspond to respective branches at the second stage. For example, in an actual road shown in FIG. 4(b), in a case where the first stage has two branches and there exist second-stage branches respectively down the right and left roads that are branched, the illustration (illustration 1 of FIG. 4(b)) where the left road is expressed in the multistage branches corresponds to the illustration (illustration 2 of FIG. 4(b)) where the right road is expressed in the multistage branches. According to such the correspondence, the maximum number of the final outgoing directions expressed in one branch illustration is five directions (in a case where three branches exist at the first stage, and three branches exist at the second stage with respect to any one of the left, right and center roads thus divided).

### [3. Configuration or the Like of Illustration Pattern Table or the Like]

Next, configuration or the like of an illustration pattern table is described with reference to FIGS. 4 to 18.

An illustration pattern table (an example of road pattern list) is list-form data that express correspondence between a road pattern at a branch point and a branch illustration, ID or the like.

Such the illustration pattern table, an entire assignment list described later, a difference pattern list, or the like are created based on the network data.

The entire assignment list (an example of branch point pattern list) is list-form data that express road patterns respectively corresponding to entire branch points that are subject to be assigned with illustration in the subject area.

Further, in a case where a pattern change list by point is list-form data that express road patterns after the assignment by branch point in a case where the road pattern changes at a given branch point.

Further, a difference pattern list is list-form data that express road patterns not existing in the current illustration pattern table, among road patters at respective branch points obtained from the network when there are changes in network data, data specification, information creation program, and the like.

Each of these illustration pattern tables, entire assignment list, pattern change list by point, and difference pattern list includes a field indicating a road pattern of the same form in one record (an example of road pattern data).

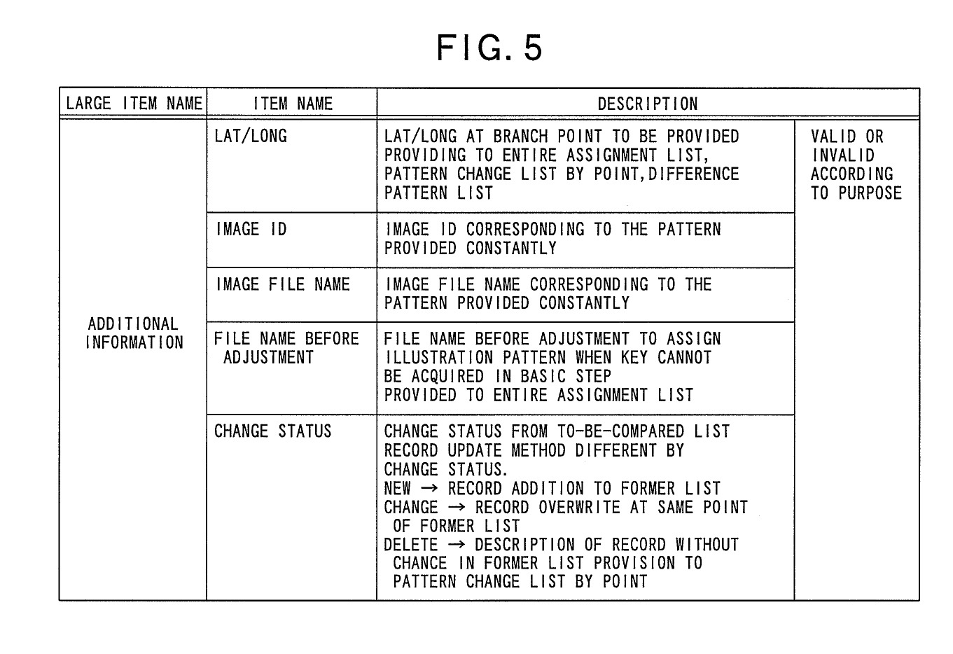

FIGS. 5 to 7 are views showing an example of configuration of one record in an illustration pattern table or the like.

As shown in FIG. 5, additional information consisting of first latitude/longitude of the branch point (an example of point identification information), an image ID, an image file name corresponding to a road pattern (an example of image identification information), a file name before adjustment, a change status are set in one record of the illustration pattern table or the like. Fields set with these of the information are provided in response to types of outputted data. For example, an image ID and an image file name are set up in case of the illustration pattern table, latitude and longitude, an image ID, an image file name, and a file name before adjustment are set up in case of the entire assignment list, and latitude and longitude, an image ID, and an image file name are set up in a case of the difference pattern list.

Hereinafter, overall information, left first stage, left second stage, right first stage, right second stage, center first stage, and center second stage are information provided with a field regardless of data types.

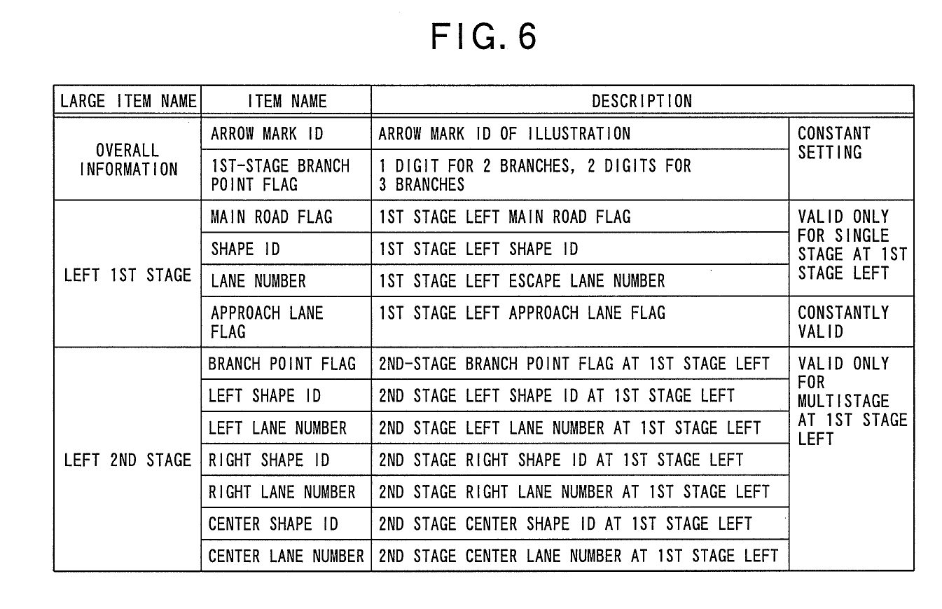

As shown in FIG. 6, overall information that is provided to all road patterns. Further, the left first stage is information related to a first-stage left outgoing lane. Further, left second stage is information set up in a case where a second-stage branch point exists in the first-stage left outgoing lane.

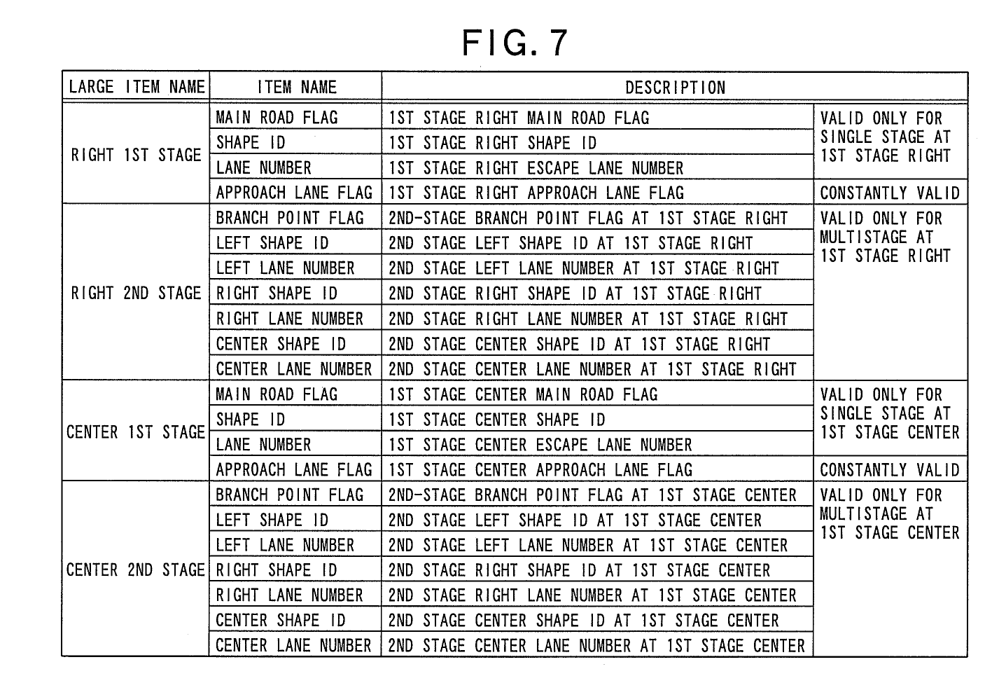

Next, as shown in FIG. 7, a right first stage is information related to the right first-stage outgoing lane. Further, a right second stage is information set up in a case where a second-stage branch point exists in the first-stage right outgoing lane. Further, a center first stage is information related to the first-stage center outgoing lane when the first stage has three branches. Further, center second stage is information set up in a case where the second-stage branch point exists at the first-stage center outgoing lanes.

Respective items of these of the information are described in detail hereinafter.

### [3.1 Identification of Branch Node]

First, a judgment method for judging to which node among original network a branch illustration is assigned is described. In the present embodiment, when the node satisfies both conditions (1) and (2) as described below, the node is identified as a branch node and a branch illustration is assigned.

(1) In a link connected in a direction of incoming into the node, for example, one link, where a road type (or information indicative of road type, section, or the like) is freeway and separation main road (indicative of main road) or ramp link (indicative of ramp way), is connected.
(2) In a link connected in a direction of outgoing from the node, one link, where a link type is a separation main road or ramp link, is connected.

Here, a link satisfying the condition (1) is identified as an incoming link (indicative of incoming road), and a link satisfying the condition (2) is identified as an outgoing link (indicative of outgoing road).

### [3.2 Arrow Mark ID]

An arrow mark ID is information indicative of an outgoing direction, i.e. on which outgoing road an arrow mark 4 shown in FIGS. 2 and 3 is displayed. Such the arrow mark ID is included in overall information.

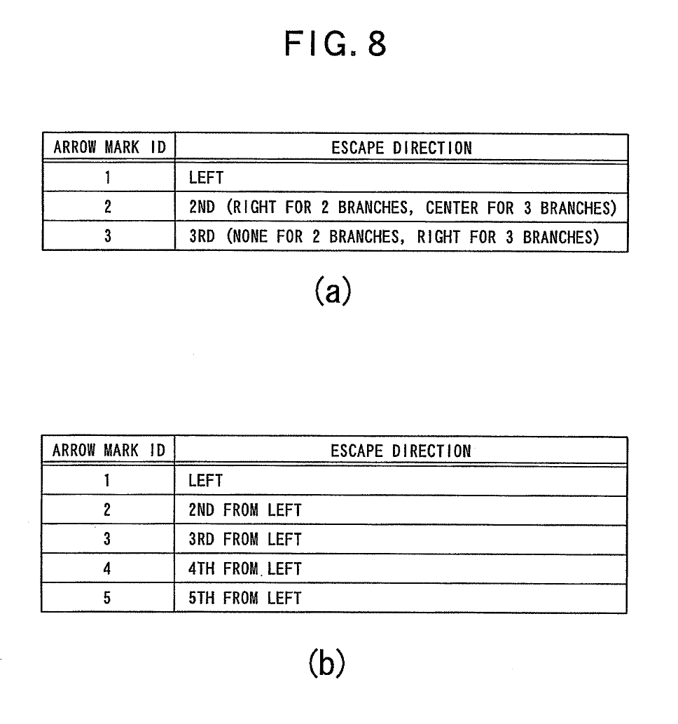

FIG. 8 is a view showing an example of assignment condition of an arrow mark ID. (a) is a case of single-stage branch and (b) is a case of multistage branch.

In a case of single-stage branch shown in FIG. 8(a), arrow mark IDs 1, 2, and 3 are sequentially assigned from the left side of the outgoing direction. In a case of multistage branch shown in FIG. 8(b), arrow mark IDs 1 to 5 are sequentially assigned from the left side of the outgoing direction.

FIG. 9 is a view showing an example of assignment of an arrow mark ID. (a) is a case of single-stage two branches, (b) is a single-stage three branches, and (c) and (d) are cases of multistage branch.

According to the assignment conditions, an arrow mark ID is assigned respectively to outgoing directions, as shown in FIG. 9. As shown in FIGS. 9(c) and (d), in a case of multistage branch, the arrow mark ID is assigned based on the outgoing direction regardless of the first-stage outgoing road or the second-stage outgoing road.

### [3.3 Branch Point Flag]

A branch point flag (an example of borderline existence information) is information indicative of existence of incoming lane line corresponding to a branch between two adjacent outgoing roads as shown in FIGS. 2(a) and (b). This branch point flag is included in the overall information, the left second stage, the right second stage, and the center second stage.

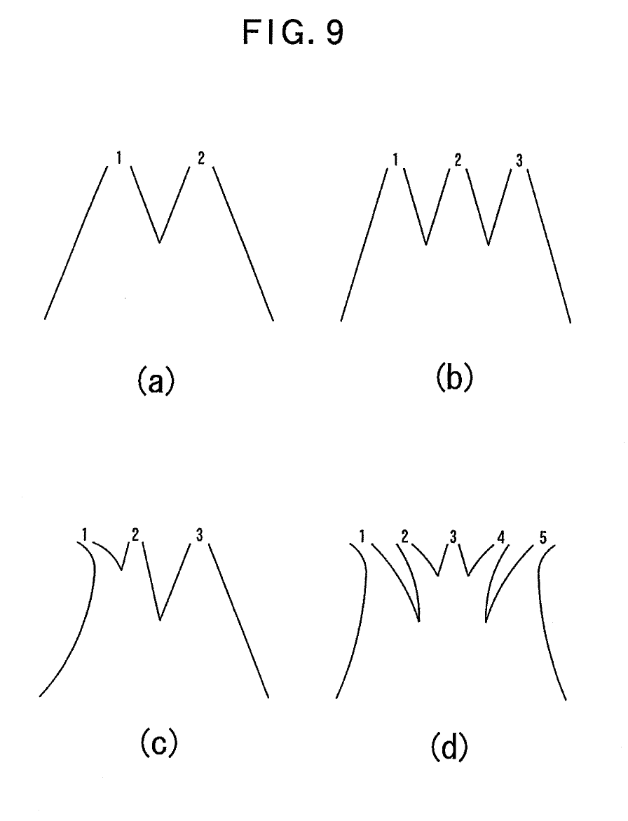

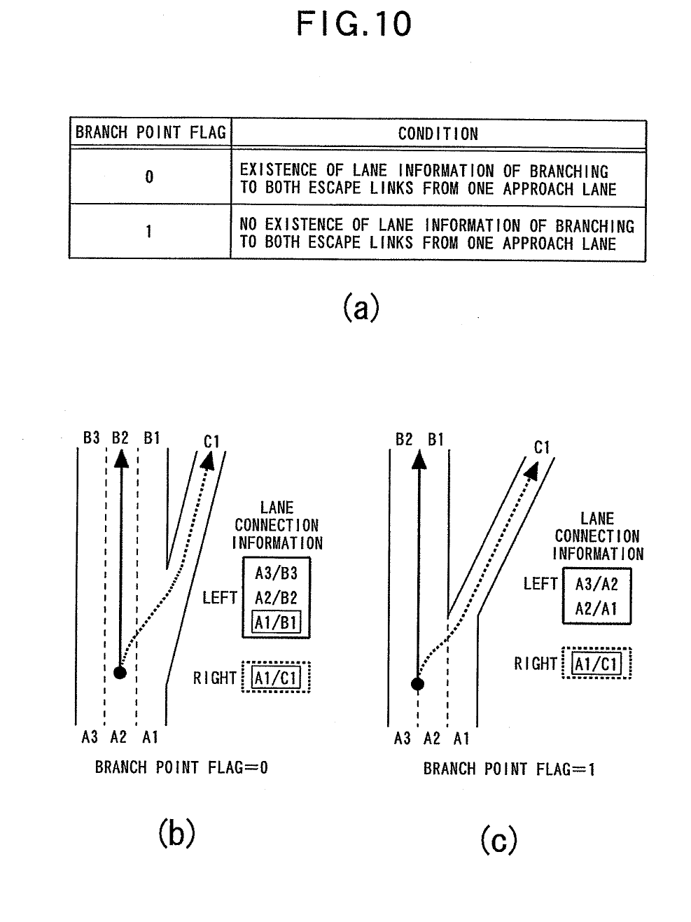

FIG. 10(a) is an example of setting conditions of the branch point flag. FIGS. 10(b) and (c) are views showing a setting example of the branch point flag.

With respect to the branch point flag, one is set up in a case of two branches and two is set up in a case of three branches. The branch point flag is set up based on connection information (an example of lane connection information) of a lane between two outgoing links adjacent to an incoming link connected to the branch node of the original network data.

Specifically, for example, in a case where an incoming lane A1 among incoming lanes A1 to A3 is connected to the lanes (B1, C1) being both left and right outgoing roads as shown in FIG. 10(b), 0 is set up into a branch point flag. In a case where no lane among incoming lanes A1 to A3 is connected to both left and right outgoing roads as shown in FIG. 10(c), 1 is set up in a branch point flag.

### [3.4 Main Road Flag]

A main road flag is information that shows whether or not the outgoing road is a main road, as shown in FIG. 2(c). This main road flag is included in the information of left first stage, right first stage, and center first stage.

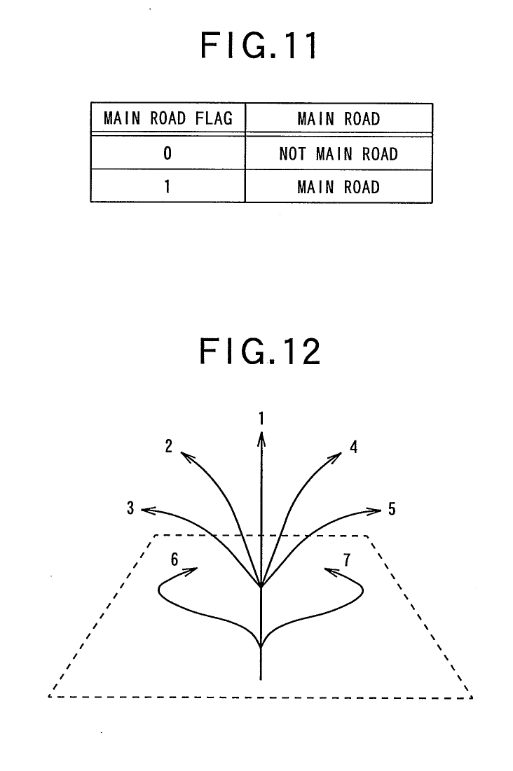

FIG. 11 is a view showing an example of setting conditions of the main road flag.

The main road flag is, for example, single-stage two branches and the lane number of outgoing link on both left and right sides is one in the original network data. In a case where the road type of the outgoing link is a main road, 1 is set up, and in a case where the type is not a main road, 0 is set up.

### [3.5 Shape ID]

A shape ID (an example of shape pattern information) is information indicative of a shape of outgoing road. Among previously patterned road shapes, a pattern close to the actual road shape of the respective outgoing roads is respectively assigned. With respect to such the shape ID, one ID is included respectively in information of the left first stage, right first stage, and center first stage, and maximum three IDs are included in information of left second stage, right second stage, and center second stage (two IDs in a case of two branches in the second stage, three IDs in a case of three branches).

FIG. 12 is a view showing an example of a shape ID and an image of a road shape corresponding to one on the illustration.

As shown in FIG. 12, there are seven types of shape IDs from 1 to 7 in the present embodiment. They show straight, left small angle, left large angle, right small angle, right large angle, left bulge, and right bulge in order from 1. However, as explained in the example of the branch illustration, five type of straight, left small angle, left large angle, right small angle, and right large angle (shape IDs 1 to 5) are actually expressed on the illustration, and left bulge and right bulge (shape IDs 6 to 7) are converted from the other shape ID by shape ID conversion described later.

The shape ID is set up to respective outgoing roads based on information indicative of road shape of the original network data.

Specifically, for example, interpolation points of an incoming link from a branch node of the network data are followed by the predetermined distance in direction opposite to a travel direction, a road shape of an incoming road is identified from the lat/long information or the like of the interpolation points, interpolation points of respective outgoing links from a branch node are followed by the predetermined distance in travel direction (outgoing direction) again, and a road shape of the outgoing road is identified from the lat/long information or the like of the interpolation points.

More particularly, lat/long information of an interpolation point (hereinafter, referred to as subject point) located by the predetermined distance is acquired, and an angle of a straight line between two subject points in predetermined direction (e.g. X axis direction, east direction) is acquired from the lat/long information of a nth subject point (n being natural number) and a subject point (first branch node) of “n+1”th and acquired as an angle alignment. However, when the incoming link is followed, in a case where a confluence node (node from plural links) exists in the course, acquisition is made up to the node. When the outgoing link is followed, in a case where the branch node also exists in the course, acquisition is made up to the node.

A distance interval and alignment number (i.e. the number of pieces acquiring the angle) to acquire this angle alignment, for example, are provided as an initial value and a parameter of the information generation process program.

FIG. 13(a) is a view showing an example of image of acquiring the angle alignment, and FIG. 13(b) is an example of computing equation of judgment angle for assigning the shape ID based on the angle alignment.

In the example of FIG. 13, the distance interval is set up to be 100 m and the alignment number is set up to be 2 for acquiring the angle alignment to the incoming link and the distance interval is set up to be 100 m and the alignment number is set to be 3 for acquiring the angle alignment to each the outgoing link. In FIG. 13(a), angles i1 and i2 to the incoming link and angles o1, o2, and o3 to the outgoing link are acquired. An incoming angle θin and an outgoing angle θout are calculated by the computing equation shown in FIG. 13(b). Specifically, an average value of respective angles of the angle alignment of the incoming link is set up to be an incoming angle θin. A difference between the average values of respective angles of the angle alignment of the outgoing link and the incoming angle is set up to be an outgoing angle θout.

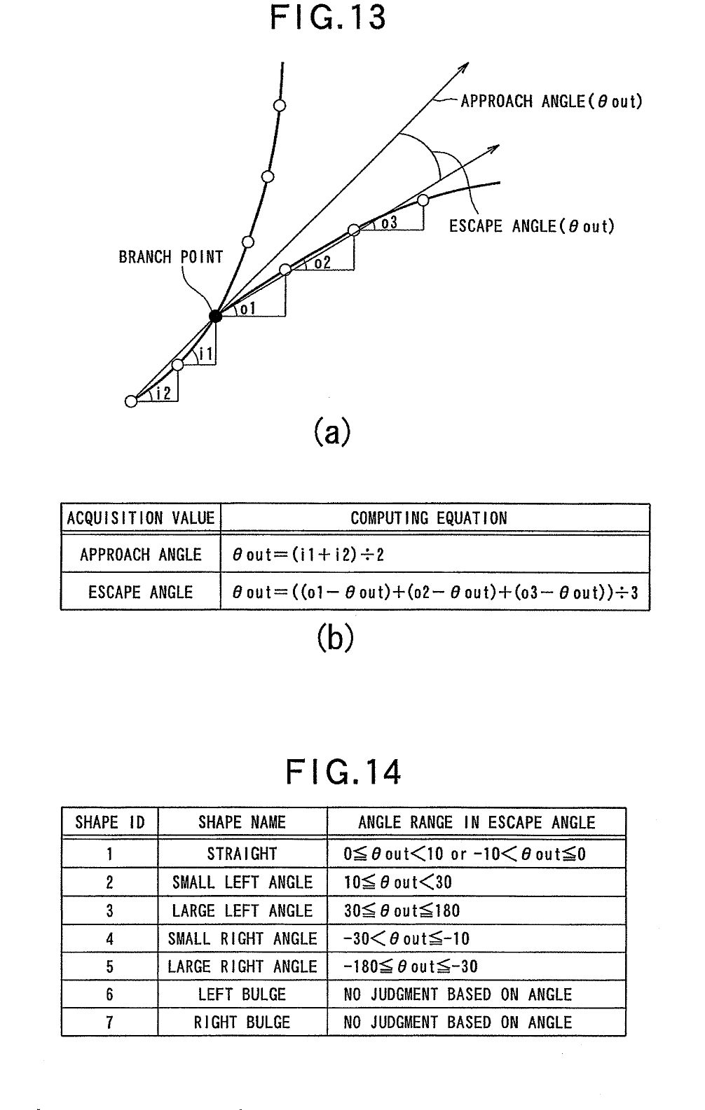

FIG. 14 is a view showing an example of setting conditions of a shape ID.

As shown in FIG. 14, the shape ID is set up in correspondence with the outgoing angle θout acquired by the above-mentioned computing. The other judgment method may be used for judging the shape ID.

Upon the acquisition of shape IDs on all outgoing links in such way, in a case where the combination (pattern) matches a predetermined combination, at least one shape ID of them is converted to a different shape ID.

One of the reasons is that the number of combination is reduced to thereby reduce the number of illustrations of branch to be created. Depending on combinations of shape IDs, there are cases where a road shape corresponding to the shape ID as it is cannot be expressed with an illustration and a case where simplification causes no problem. For example, in the single-stage two branches, when a shape ID of the left outgoing link is 1 (straight) and a shape ID of the right outgoing link is 2 (left small angle), it is considered to cause no problem that a shape ID of the right outgoing link is converted to 1 (straight).

As the second reason, it is for expressing road shapes except for straight, left small angle, left large angle, right small angle, and right large angle to express branch illustrations better. In this case, the conversion is made into a shape ID of a special road shape (e.g. 6 onward).

The condition for such the shape ID conversion is previously created as table data and memorized in the memory unit 12.

Here, with respect to the above two conversions, any one may be conducted, both may be combined and conducted, or conversion may be conducted based on the other view.

### [3.6 Lane Number]

The lane number designates a number of lanes of the outgoing roads, and one lane is set up with respect to each of the outgoing links. As to this lane number, information of left first stage, right first stage, and center first stage respectively includes one lane, information of left second stage, right second stage, and center second stage include maximum three lanes (two lanes in a case where the second stage includes two branches, and three lanes in a case where the second stage includes three branches).

Basically, setting is made based on lane connection information and information indicative of the lane number of the original network data.

However, in a case where a large number of lanes exist in the actual road, the illustrations are not easy for the user to see in some cases, even if the entire lanes are expressed as they are on the branch illustrations. Further, there is a possibility that the number of branch illustrations becomes vast when combinations of actual lane numbers are all covered to express. Then the predetermined upper limit is provided to the lane number to be set, and the lane number is adjusted to be not more the upper limit (to reduce the lane number).

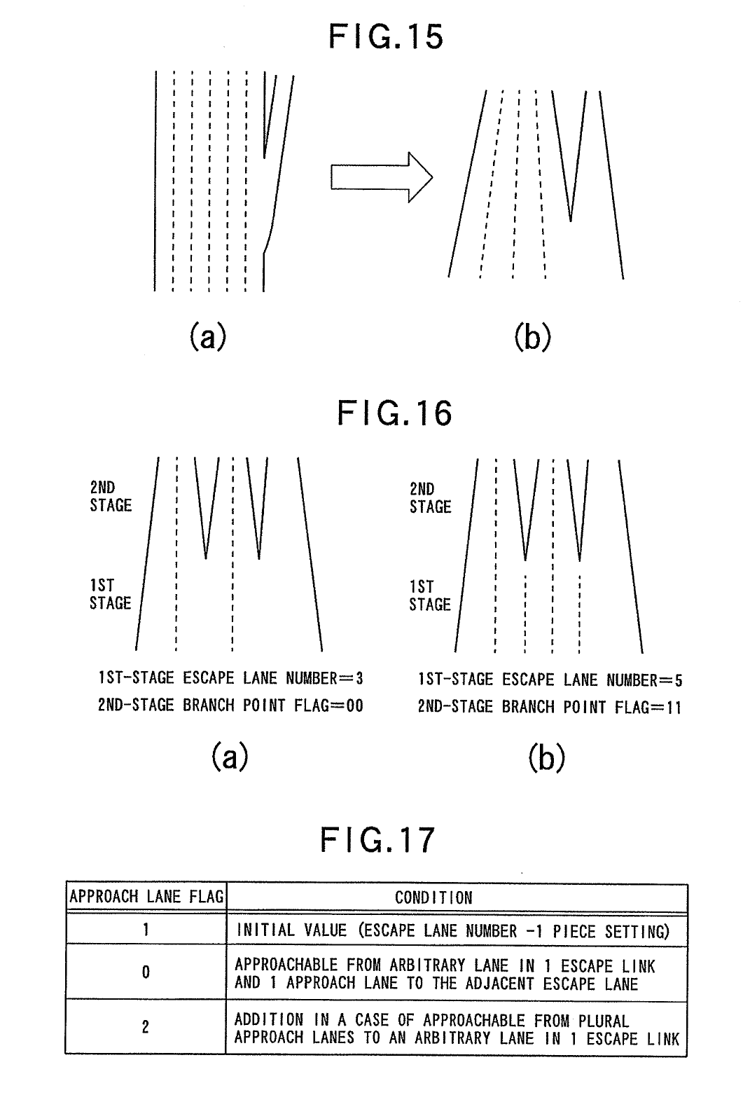

FIG. 15 is a view showing an example of an adjustment image of lane number in the single-stage branch. (a) is an actual road and (b) is a branch illustration after the lane number adjustment. This drawing is an example of a case where the upper limit of the total lane number of all outgoing links is set to 5.

As shown in FIG. 15(a), in a case where the lane number of the actual roads is 7 in total including 6 for left side and 1 for right side, the lane number is adjusted to be 5 in total. Specifically, it is reduced to 4 for left side, as shown in FIG. 15(b). Here respective lane numbers are adjusted so as to make a ratio of the lane number of the respective outgoing links after the adjustment close to the ratio of lane numbers of respective outgoing links before the adjustment. For example, in a case where the actual number of left side lanes is 4 and the actual number of right side lanes is 3 when the upper limit is 5, the number is reduced to 3 and 2 respectively.

Further, not only the total of the lane number of entire outgoing links but also the upper limit may be provided to one outgoing link. For example, in a case where the number of the actual left side lanes is 6 when the upper limit of the lane number of one outgoing link is set up to be 4, the number is reduced to 4.

FIG. 16 is a view showing an example of the adjustment image of the lane number in the multistage branch.

In the multistage branch, the total number of lanes of the outgoing link at branch in the second stage is adjusted to match that of the branch in the first stage. This is because information of the lane number of the first stage is more important for the user than information of the lane number of the second stage.

Specifically, the total lane numbers of the outgoing link in the second stage is adjusted so as to match the total of the lane numbers of the first-stage outgoing link and the number where the second-stage branch point flag is 0.

For example, as shown in FIG. 16(a), in a case where the lane number of the first-stage outgoing link is 3 and the second-stage branch point flag is 00, respective lane numbers are adjusted so as to make the total lane number of the second-stage outgoing link 5. Here, a ratio of the lane number of respective outgoing link after the adjustment is also adjusted to so as to make respective lane numbers close to a ratio of the lane numbers of respective outgoing link before the adjustment.

Further, as shown in FIG. 16(b), in a case where the lane number of the first-stage outgoing link is 5 and the second-stage branch point flag is 11, respective lane numbers are adjusted so as to make the total lane numbers of the second-stage outgoing link 5.

Here, in a case where it is impossible to adjust by the above-mentioned method, the branch point flag is converted.

For example, the lane number of the first-stage outgoing link is 1, the lane number of the respective outgoing links in the second stage are 1 respectively, and the second-stage branch point flag is 1, the branch point flag is converted to 0 because the lane number of the outgoing link cannot be reduced any longer.

On the contrary, in either FIG. 16(a) or (b), in a case where a total lane number of second-stage outgoing links is smaller than a total lane number of first-stage outgoing links and the number when the second-stage branch point flag is 0, the lane number of respective outgoing links in the second stage is increased for adjustment.

Here, in a manner similar to the case of the single-stage branch, an upper limit value may be provided to one outgoing link for adjustment.

### [3.7 Approach Lane Flag]

An incoming lane flag (an example of borderline correspondence information) is information that indicates a corresponding relation between a lane line of the incoming road and a lane line of the outgoing road, and it is set up from a left lane line by a difference of the number corresponding to the lane line. Such the incoming lane flag is set up at the first stage of the single-stage branch or the multistage branch, and one flag is included respectively in information of left first stage, right first stage, and center first stage.

FIG. 17 is a view showing an example of setting conditions of the incoming lane flag.

The incoming lane flag is set up based on the lane connection information of the original network data.

Specifically, as shown in FIG. 17, the lane number of respective outgoing links are acquired and 1 is set up by 1 piece of this lane number as an initial value of the incoming lane flag. 1 indicates that a given incoming lane line follows along the outgoing lane line. In a case where one incoming lane is connected to both of a given lane inside the outgoing link and the lane adjacent thereto, a position corresponding to the incoming lane flag is converted and set up to be 0.0 indicates that the incoming lane line following to the outgoing lane line does not exist. Further, in a case where plural incoming lanes are connected to the lane inside the outgoing link, 2 is added (inserted) to the position corresponding to the current incoming lane flag. 2 indicates that the outgoing lane line following a given incoming lane line does not exist.

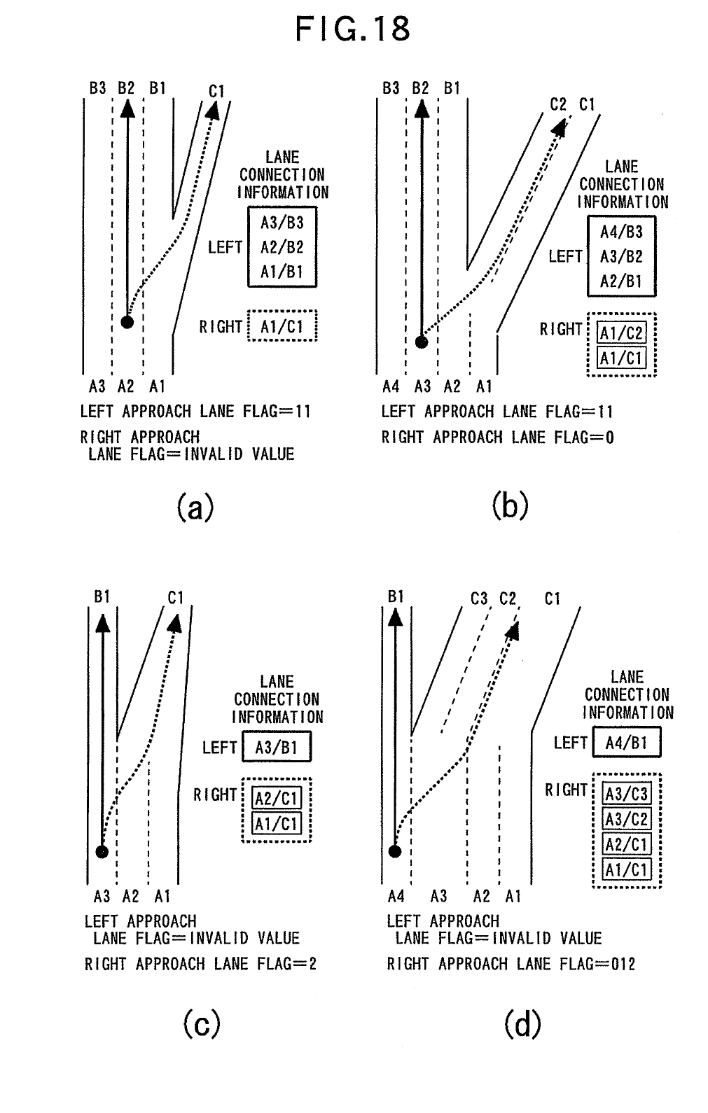

FIG. 18 is a view showing a setting example of the incoming lane flag.

In an example of FIG. 18(a), because the lane number of left outgoing link is 3, and an incoming lane to connect to plural outgoing lanes dose not exist nor does an outgoing link lane to connect plural incoming lanes exist, an initial value 11 is set up into the left incoming flag. Meanwhile, because the lane number of the right outgoing link is 1, invalid value (e.g. −1) is set up into the incoming lane flag.

Next, in an example of FIG. 18(b), the lane number of a right outgoing link is 2, and an incoming lane A1 is connected to outgoing lanes C1 and C2. In this case, 0 is set up into the right incoming lane flag.

Further, in an example of FIG. 18(c), the lane number of a right outgoing link is 1, and incoming lanes A1 and A2 are connected to an outgoing lane C1. In this case, 2 is set up into the right incoming lane flag.

Further, in an example of FIG. 18(d), the lane number of a right outgoing link is 3. Approach lanes A1 and A2 are connected to an outgoing lane C1, and an incoming lane A3 is connected to outgoing lanes C2 and C3. In this case, 012 is set up into the right incoming lane flag.

### [4 Operation of Data Creation System]

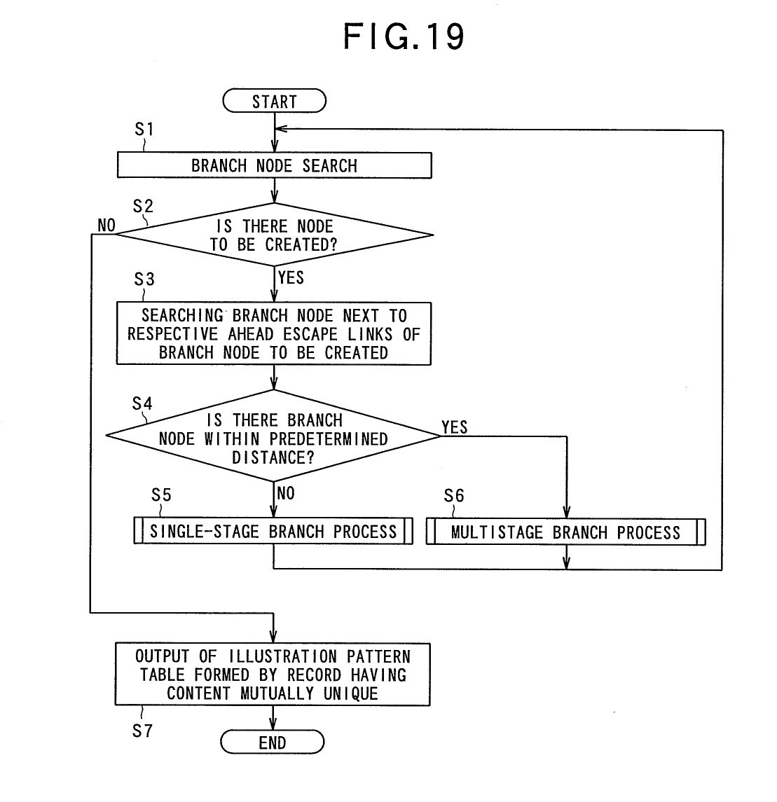

Next, an action of the data creation system S is described with reference to FIGS. 19 to 24.

First, a case where the illustration pattern table is created from the original network data is described.

FIG. 19 is a flowchart showing a process example of the system control unit 11 of the data creation system S related to the present embodiment.

As shown in FIG. 19, when starting information generation process program, the system control unit 11 first searches a node in the network data memorized in the memory unit 12. As explained in the above-mentioned item 3.1, the system control unit 11 identifies a branch node being a subject to be created and an incoming link and an outgoing link connected to the branch node (Step S1).

Next, the system control unit 11 judges whether or not the branch node being a subject to be created exists (Step S2). In a case where the branch node exists, the system control unit 11 follows respective outgoing links connected to the node and searches next branch node within a predetermined distance from the node (Step S3). Then the system control unit 11 judges whether or not the next branch node exists within a predetermined distance (Step S4). In a case where the next branch node does not exist (Step S4: NO), the system control unit 11 judges the branch node to be created as a single-stage branch and carries out a single-stage branch process (Step S5). In a case where the next branch node exists (Step S4: YES), the system control unit 11 judges the branch node to be created as a multistage branch and carries out a multistage branch process (Step S6).

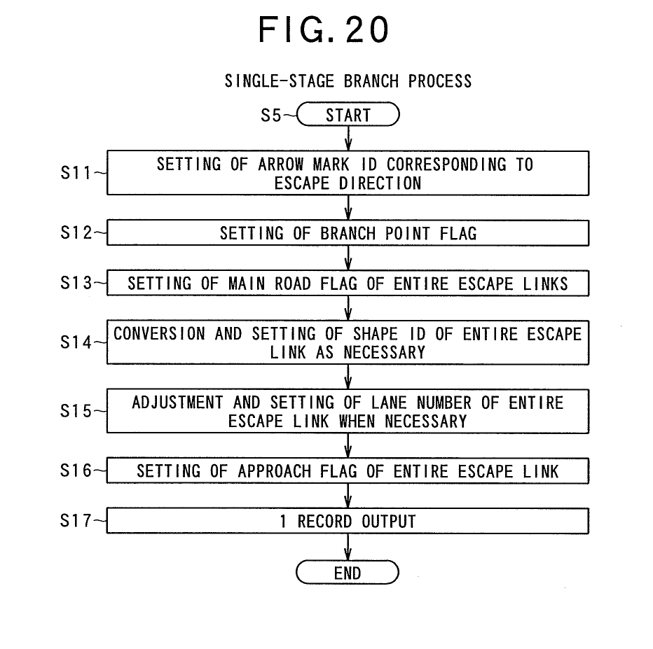

FIG. 20 is a flowchart showing an example of the single-stage branch process of the system control unit 11 of the data creation system S related to the present embodiment.

In the single-stage branch process shown in Step S5, the system control unit 11 secures a work area of one record road pattern on RAM, as shown in FIG. 20. As described in the above item 3.2, the system control unit 11 sets up the arrow mark IDs (overall information) from the leftmost of the identified outgoing link in the work area (Step S1).

Then, as described in the above item 3.3, the system control unit 11 sets up the branch point flag (overall information) in the work area (Step S12), and as described in the above item 3.4 sets up the main road flag in the work area with respect to the all outgoing links (left first stage, right first stage, and center first stage, hereinafter in a manner similar to this) (Step S13). Subsequently, as described in the above item 3.5, the system control unit 11 sets up a shape ID in the work area with respect to all outgoing links, and converts this shape ID when necessary (Step S14).

Next, as described in the above item 3.6, the system control unit 11 acquires the lane number with respect to all outgoing links, adjusts it when necessary, and then sets up it in the work area (Step S15). As described in the above item 3.7, the system control unit 11 sets up an incoming lane flag with respect to all outgoing links (Step S16).

Then the system control unit 11 outputs one record of the road pattern set up in the work area to the memory unit 12 (Step S17) and finishes the single-stage process.

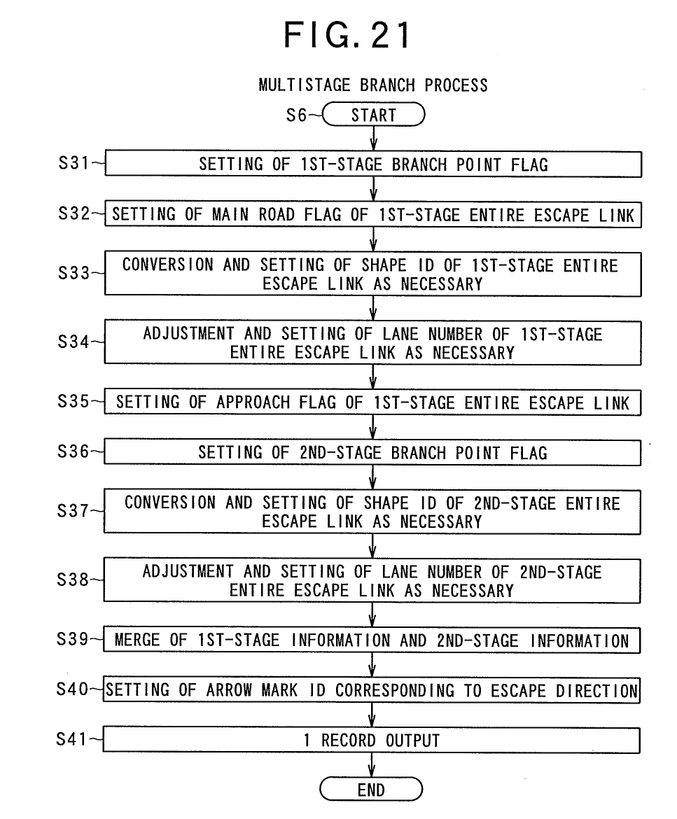

FIG. 21 is a flowchart showing an example of the multistage branch process of the system control unit 11 in the data creation system S related to the present embodiment.

In the multistage branch process shown in Step S6, the system control unit 11 obtains a work area of one record road pattern on RAM as shown in FIG. 21. In a manner similarly to the case of the single-stage branch (Steps S12 to S16), the system control unit 11 sets up a branch point flag, main road flag, shape ID, lane number and incoming flag in the work area with respect to branch first stage (overall information, left first stage, right first stage, and center first stage) (Steps S31 to S35). However, with respect to the lane number, the system control unit 11 carries out lane adjustment in response to the multistage branch first stage as described in the above item 3.6.

Next, the system control unit 11 sets up the branch point flag, shape ID, and lane number in the work area with respect to branch second stage (left second stage, right second stage, and center second stage) in a manner similar to the case of the single-stage branch (Steps S36 to S37). However, with respect to lane number, the system control unit 11 carries out lane adjustment in response to the multistage branch second stage as described in the above item 3.6.

Then the system control unit 11 merges (combines) the first-stage information and the second-stage information and sets invalid value (e.g. −1) to unnecessary information (e.g. main road flag, shape ID, lane number in the first stage of the multistage branch) (Step S39).

Next, the system control unit 11 sets up an arrow mark ID (overall information) in response to the outgoing link subjected to be processed in the work area (Step S40).

Then, the system control unit 11 outputs (memorizes) one record of the road pattern set up in the work area to the memory unit 12 (Step S41), and finishes the multistage process.

Back to FIG. 19, after the single-stage branch process or the multistage branch process finishes (Steps S5 and S6), a node in the network data is searched again (Step S1).

Then, upon the completion of entire node search, when judging that a branch node subjected to be created does not exist in Step S2 (Step S2: NO), the system control unit 11 creates the illustration pattern table consisting of only record different from the road pattern among the records created so far, sets up an image ID to respective records (e.g. setting from 1 in order), and outputs this illustration pattern table in the memory unit 12 (Step S7).

Accordingly, upon the creation of the illustration pattern table, operators make the other computer to display the content of the illustration pattern table on the display, print out it on paper, or the like, and create the image data of the branch illustration while referring to the content of respective records of the illustration pattern table. Further, operators set file names of the image data of the corresponding branch illustration up to respective records of the illustration pattern table.

Next, processes of creating an entire assignment list, difference pattern list or the like is described using the illustration pattern table thus created.

For example, this is carried out in a case of correlating the branch point to the illustration of branch and also in a case where the content of the network data to be an original changes after the illustration pattern table is once created and a change to give influence to road pattern judgment is effected on the information generation process program (e.g. changes in an upper limit of lane number, in judgment method of a shape ID, and in a parameter of distance interval, angle intervals and the like).

First, in a case where the original network data and the information generation process program are changed, those after the change are memorized in the memory unit 12.

Further, the illustration pattern table set up to have file names of the image data is memorized in the memory unit 12. Here those created by the above-mentioned processes of the system control unit 11 may be used for such the illustration pattern table, or for example those previously created with respect to typical road patterns by operators may be used.

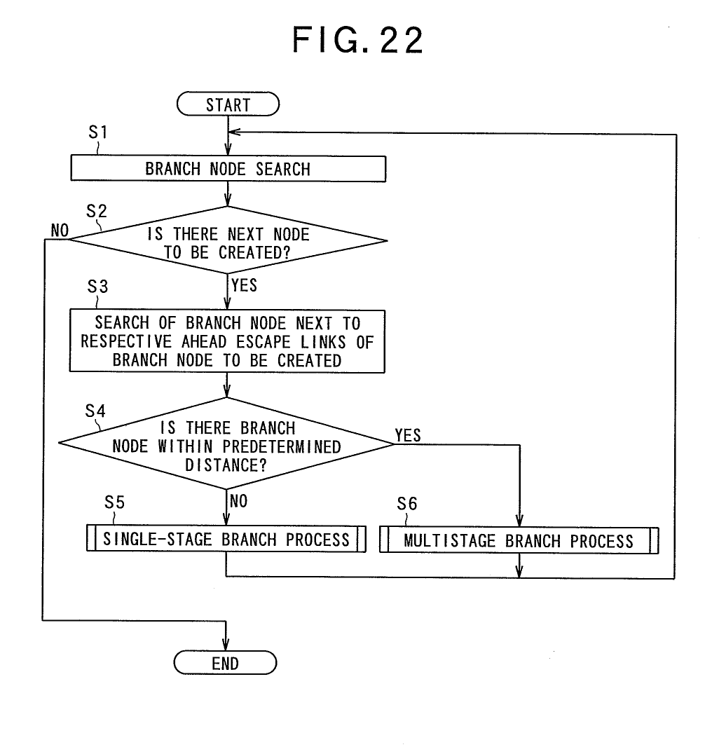

FIG. 22 is a flowchart showing a process example of the system control unit 11 in the data creation system S related to the present embodiment. In FIG. 22, the reference numerals in FIG. 19 are similarly used for elements similar thereto.

As shown in FIG. 22, the system control unit 11 judges the single-stage branch or the multistage branch with respect to the branch node subject to be created and carries out the single-stage branch process or the multistage branch process.

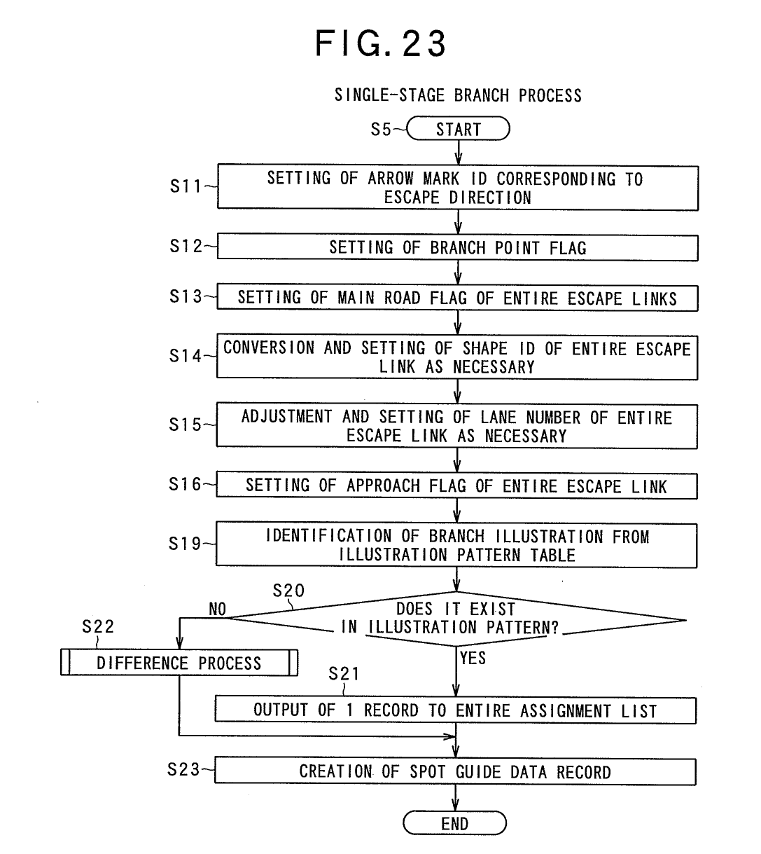

FIG. 23 is a flowchart showing an example of a single-stage branch process of the system control unit 11 in the data creation system S according to the present embodiment. In FIG. 23, reference numerals in FIG. 20 are similarly used for the elements similar thereto.

As shown in FIG. 23, the system control unit 11 sets up an arrow mark ID, branch point flag, main road flag, shape ID, lane number, and incoming flag in the work area in a manner similar to the case of FIG. 20 (Steps S11 to S16).

Next, the system control unit 11 identifies from the illustration pattern table a record having a pattern that matches the road pattern of the branch point to be created using the above-mentioned set information as a search key (Step S19).

Then, the system control unit 11 judges whether or not the road pattern exists in the illustration pattern table (Step S20). In a case of existence (Step S20: YES), the system control unit 11 sets up lat/long information of the branch point to be created, the identified record image ID, and file name of the image data in the work area, and outputs (memorizes) the information thus set in the work area as one record of the entire assignment list, to the memory unit 12 (Step S21).

On the contrary, in a case where the road pattern does not exist in the illustration pattern table (Step S20: NO), the system control unit 11 carries out a difference process described later (Step S22).

Subsequently, the system control unit 11 creates a spot guide data record having a guiding point in a direction of the outgoing link set up with an arrow mark ID (Step S23), and finishes the single-stage process.

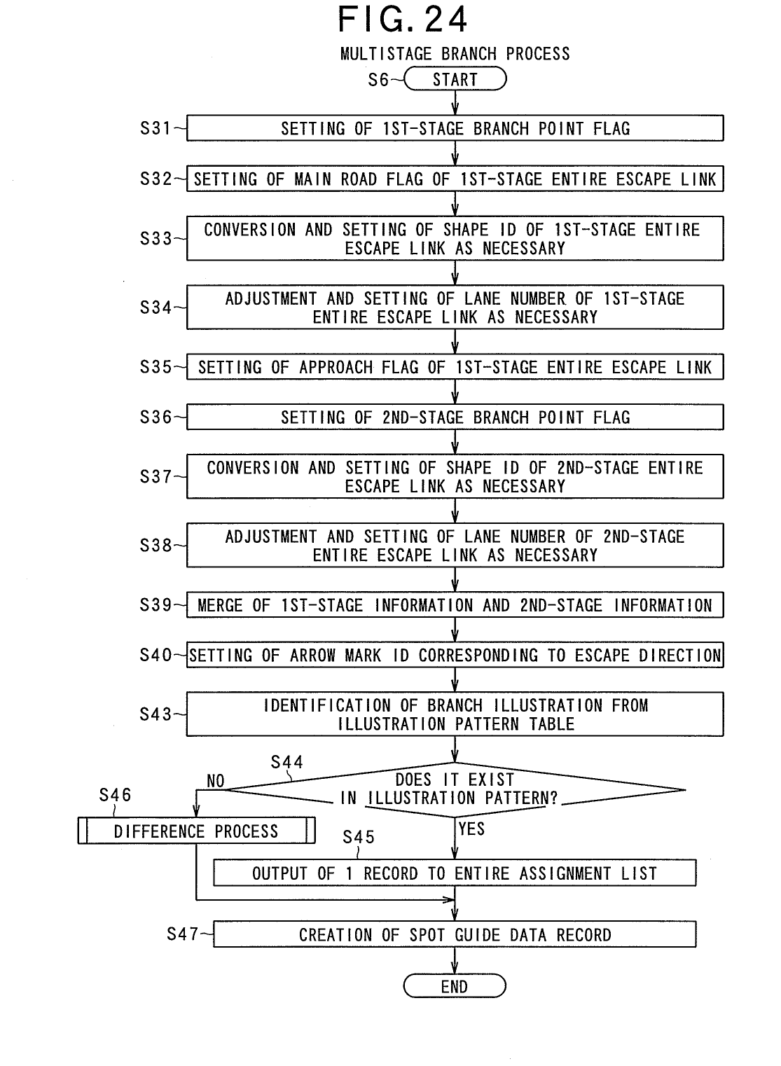

FIG. 24 is a flowchart showing an example of a multistage branch process of the system control unit 11 in the data creation system S related to the present embodiment. In FIG. 24, reference numerals in FIG. 21 are similarly used for the elements similar thereto.

As shown in FIG. 24, the system control unit 11 sets up branch point flag, main road flag, shape ID, lane number, and incoming flag in the work area with respect to branch first stage, in a manner similar to the case of FIG. 21. Next, the system control unit 11 sets up branch point flag, shape ID lane number, and lane number in the work area with respect to branch second stage, subsequently merges (combines) the first-stage information and the second-stage information, and sets up the arrow mark ID in the work area (Steps S31 to S40).

Next, the system control unit 11 identifies from the illustration pattern table a record having a pattern that matches the road pattern of the branch point subject to be created using the above-mentioned set information as a search key (Step S43).

Then, the system control unit 11 judges whether or not the road pattern exists in the illustration pattern table (Step S44). In a case of existence (Step S44: YES), the system control unit 11 sets up lat/long information of the branch point subject to be created, the identified record image ID, and the file name of an image data in the work area, and outputs the information thus set up in the work area as one record of the entire assignment list, to the memory unit 12 (Step S45).

On the contrary, in a case where the road pattern does not exist in the illustration pattern table (Step S44: NO), the system control unit 11 carries out a difference process described later (Step S46).

Subsequently, the system control unit 11 creates a spot guide data record having a guiding point in a direction of the outgoing link set up to have an arrow mark ID (Step S47), and finishes the multistage process.

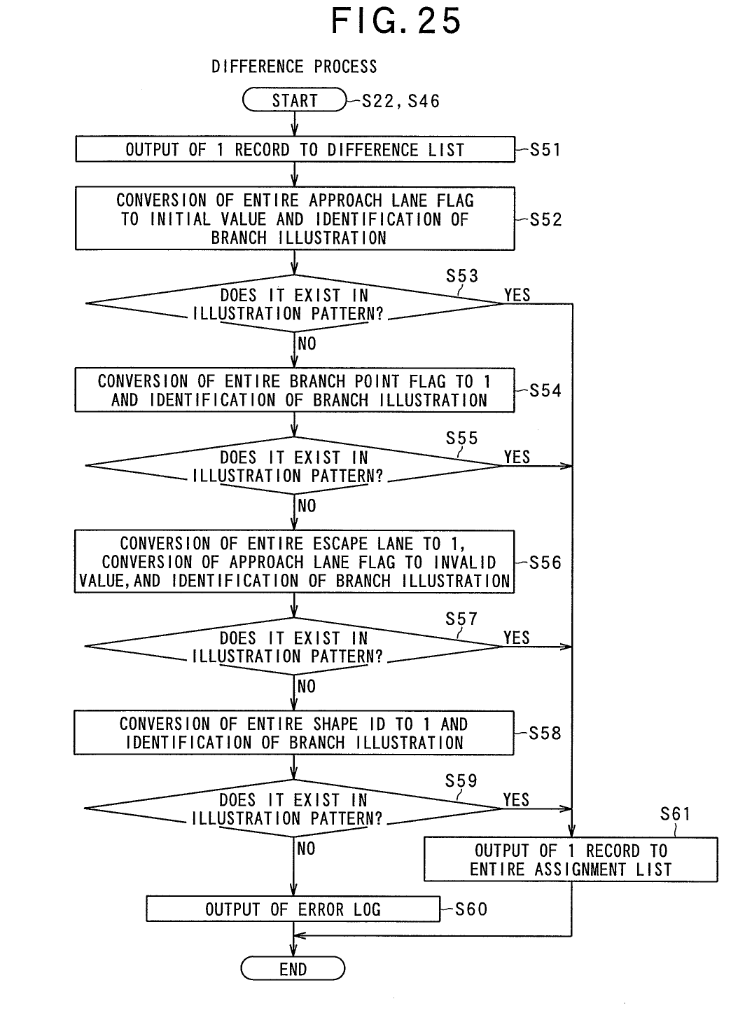

FIG. 25 is a flowchart showing an example of a difference process of the system control unit 11 in the data creation system S related to the present embodiment.

In a difference process shown in Steps S22 and S46, as shown in FIG. 25, the system control unit 11 outputs information thus set up in the work area in the single-stage process or the multistage process as one record of the difference pattern list to the memory unit 12 (Step S51).

Thereafter, the system control unit 11 carries out an adjustment process so as to assign any branch illustration to the branch point subject to be created.

Specifically, the system control unit 11 converts all incoming flags to an initial value (converting 0 to 1 and deleting the added 2), and subsequently identifies from the illustration pattern table a record having a pattern that matches the road pattern of the branch point to be created (Step S52).

Next, the system control unit 11 judges whether or not the road pattern exists in the illustration pattern table (Step S53). In a case of no existence (Step S53: NO), the system control unit 11 converts all branch point flags to 1 and then identifies a record having a pattern that matches the road pattern of the branch point subject to be created (Step S54).

Then, the system control unit 11 judges whether or not the road pattern exists in the illustration pattern table (Step S55). In a case of no existence (Step S55: NO), the system control unit 11 converts all outgoing lanes to 1, converts all incoming lane flags to an invalid value, and subsequently identifies a record having a pattern that matches the road pattern of the branch point subject to be created (Step S56).

Next, the system control unit 11 judges whether or not the road pattern exists in the illustration pattern table (Step S57). In a case of no existence (Step S57: NO), the system control unit 11 converts all shape IDs to 1 and subsequently identifies a record having a pattern that matches the road pattern of the branch point subject to be created (Step S58).

Then, the system control unit 11 judges whether or not the road pattern exists in the illustration pattern table (Step S59). In a case of no existence (Step S59: NO), the system control unit 11 outputs an error log to the memory unit 12 (Step S60) and finishes the difference process.

On the contrary, in a case where the road pattern exists in the illustration pattern table (Steps S53, S55, S57, S59: YES), the system control unit 11 outputs information thus set in the work area as one record of the entire assignment list to the memory unit 12 (Step S61), and finishes the difference process.

Back to FIG. 22, after the road pattern of the branch node to be created in the respective branch processes is outputted on the entire assignment list and the difference pattern list, nodes in the network data are searched again (Step S1). Then the system control unit 11 completes search of all nodes, and finishes the process when judging that the branch node subject to be created does not exist in Step S2 (Step S2: NO). Accordingly, the entire assignment list and the difference pattern list, the error log or the like is created in the memory unit 12.

Thereafter, the operators create the branch illustration with respect to the road pattern extracted as a difference pattern list, and set up a file name of the image data in the branch illustration in the difference pattern list. Then the operators merge (combine) the difference pattern list and the illustration pattern list to create a new illustration list, and create navigation data (e.g. KIWI data description type) based on such the illustration pattern list, the image data of the branch illustration, or the like.

Thus described above, according to the present embodiment, the system control unit 11 identifies the incoming link and the outgoing link at the branch point based on the network data including the lane connection information, creates the branch point flag that indicates existence of the incoming lane line corresponding to the branch between two adjacent outgoing roads based on the lane connection information between the incoming link and two adjacent outgoing links, creates the incoming lane flag that indicates a correspondence relation between the incoming lane line and the outgoing lane line based on the lane connection information between the incoming link and respective outgoing links, and creates the road pattern including the branch point flag and the incoming lane flag.

Accordingly, it is possible to create the road pattern for identifying the branch illustration to the actual branch point. Besides, because such the road pattern includes the branch point flag that indicates existence of the incoming lane line corresponding to the branch between two adjacent outgoing roads and the incoming lane flag that indicates a correspondence relation of the incoming lane line and the outgoing lane line, it is possible to capture a characteristics of the road at the actual branch point, and display the branch illustration easy for users to understand as a result. Further, it is possible to create the branch illustration while confirming the branch point flag and the incoming lane flag, so that the operation efficiency is better than creating the branch illustration while seeing the image of the actual branch point.

Further, the system control unit 11 creates the shape ID that indicates the road shape previously pattern-developed to respective outgoing links based on the node of the network data and the lat/long information of the interpolation point, or the like, and creates the road pattern including such the shape ID. Therefore, the number of patterns of the road shape is appropriately set up so that it is possible to create the branch illustration that captures the characteristics of the road shape at the branch point, and it is not necessary to create the vast number of branch illustrations to respond to all the road shapes.

Further, in a case where a combination of the shape IDs matches the predetermined combination, the system control unit 11 converts at least any single one of the shape IDs into the different shape ID, so that it is possible to reduce the number of the branch illustrations to be created.

Further, the system control unit 11 acquires the lane number of the respective outgoing roads based on the network data and in a case where the total number of lanes of all the outgoing roads exceeds the predetermined upper limit or the lane number of a single outgoing road exceeds the predetermined upper limit, the lane number is reduced. Therefore, thus created branch illustration is easy for the user to see and it is possible to reduce the number of branch illustrations to be created.

Further, because in a case where the next branch node exists within a predetermined distance of the outgoing destination of a given branch node, the system control unit 11 creates the road pattern of the multistage branch, it is possible for the user to create easy branch illustration.

Further, because the system control unit 11 creates the illustration pattern table from the road pattern different from each other, it is not necessary to create a branch illustration for all supposed road patterns. It is possible to cope with all the actual branch points when the branch illustration is created only for the road pattern included in the illustration pattern table. Therefore, operation efficiency of the illustration creation is improved.

Further, the system control unit 11 searches the illustration pattern table, identifies the branch illustration corresponding to the road pattern at respective branch points, and creates the entire assignment list made of record of the road pattern including the lat/long information of the branch point and file names of the image data of thus identified branch illustration. Therefore, it is not necessary to manually correlate the branch point to the branch illustration, and it is possible to dramatically reduce the cost required for the correlation.

Further, the system control unit 11 searches the illustration pattern table, extracts the road pattern that is not included in the illustration pattern table, and creates the difference pattern list. When there is a change in the original network data and information creation process program, the branch illustration may be created only for the road pattern extracted as the difference pattern list. Therefore, it is possible to reduce the cost required for creating illustrations for data update, system upgrade, or the like. Further, in a case where navigation data are also created for the district other than the district subject to be created so far, the branch illustrations that have been created so far are used as they are. Therefore, it is possible to correspond to new districts by creating the branch illustration only for a difference.

Further, the system control unit 11 simplifies the road patterns to assign the branch illustrations while outputting in the difference list the road pattern not existing in the illustration pattern table. Therefore, the system control unit 11 judges whether or not it is necessary to create the branch illustrations among the road patterns outputted as the difference list and may create only really necessary branch illustrations, so that it is possible to reduce the cost required for creating illustrations.

Here, although in the present embodiment, branch illustrations having arrow marks drawn in correspondence with respective outgoing directions for one branch point are assigned, for example, it may be configured that one branch illustration is assigned to the branch illustration without drawing the arrow mark, the branch illustrations are displayed on the navigation system and overlapped, and the arrow mark indicative of an outgoing direction is displayed.

Further, although in the present embodiment, branch illustrations are correlated with respect to the branch point of the freeway, for example, it may be applied in a case where branch illustrations are correlated with respect to the branch point of the toll road and the intersection.

Further, a number of branch stages, a number of branches in one stage, a distance interval and an angle alignment number for acquiring a road shape, a shape pattern, an upper limit value of lane numbers, and other parameters are not limited to those indicated by the present embodiment, and it is possible to apply by appropriately changing it.

Here, the present invention is not limited to the above-mentioned embodiment, but the embodiment is exemplification. Any one having the construction and effect substantially similar to technical concept described in the claims of the present invention is included in the technical scope of the present invention.

The entire disclosure of Japanese Patent Application (No. 2006-83107) filed on Mar. 24, 2006 including the specification, claims, drawings and abstract is incorporated herein by reference in its entirety.

1. An information generation system that generates road pattern data showing a road pattern at a branch point for identifying a road image expressing a road at a branch point on the basis of road data that includes lane connection information between roads connected at the branch point, the information generation system comprising:
a road identification device which identifies means for identifying one incoming road and a plurality of outgoing roads at the branch point based on the road data;
a borderline existence information generation device which generates means for generating borderline existence information indicating whether or not a borderline defining respective lanes of the incoming road exists in correspondence with a branch between two outgoing roads adjacent to each other, based on the lane connection information between the incoming road thus identified and two adjacent outgoing roads;
a borderline correspondence information generation device which generates means for generating borderline correspondence information that indicates a relation between a borderline defining respective lanes of the incoming road and a borderline respectively defining lanes of each of the outgoing roads, based on the lane connection information between the incoming roads thus identified and each of the outgoing roads; and
a road pattern generation device which generates means for generating the road pattern data at the branch point having the borderline existence information and the borderline correspondence information, respectively thus generated.

2. The information generation system according to claim 1, further comprising:
a shape pattern generation device which generates shape pattern information that indicates a previously determined shape with respect to each of the plurality of outgoing roads thus identified, based on the road shape information of the outgoing road,
wherein the road data include road shape information, and the road pattern generation device generates the road pattern data at the branch point including the borderline existence information, the borderline correspondence information and the shape pattern information, respectively thus generated,

3. The information generation system according to claim 2,
wherein the shape pattern generation device converts the shape pattern information of at least any one of a plurality of outgoing roads to the different shape pattern information in a case where a combination of the shape pattern information with respect to the plurality of outgoing roads matches a predetermined combination, and a number of combinations of the shape pattern information to be generated is reduced.

4. The information generation system according to claim 1, further comprising:
a lane number information generation device which generates lane number information of respective outgoing roads based on the road data of each of the plural outgoing roads,
wherein the road pattern generation device generates the road pattern data at the branch point including thus generated borderline existence information, borderline correspondence information, and lane number information.

5. The information generation system according to claim 4,
wherein the lane number information generation device reduces at least any one of the lane number information, in a case where the lane number information exceeds a predetermined number.

6. The information generation system according to claim 1, further comprising:
a judge device which judges whether or not the road pattern data that indicate the road pattern at one branch point and a road pattern in another branch point adjacent to the one branch point all together,
wherein in a case where it is judged that the road pattern data is to be generated, the branch pattern generation device generates the borderline existence information with respect to each of the one branch point and the another respective branch points, and the lane pattern generation device means generates the borderline correspondence information with respect to the one branch point; and
the road pattern generation device generates the road pattern data including the borderline existence information at the one branch point and the another branch point respectively thus generated, and the borderline correspondence information at the one branch point.

7. The information generation system according to claim 1, further comprising:
a road pattern list generation device which generates a road pattern list including the road pattern data different in road patterns among a plurality of the road pattern data thus generated by the road pattern generation means with respect to each of the branch points.

8. The information generation system according to claim 7, further comprising:
an image identification device which respectively identifies the road image showing roads at the plurality of branch points based on the plurality of road pattern data that are generated by the road pattern generation device with respect to the plurality of branch points and the road pattern list that is at least either one of a road pattern list generated with the list generation means of the road pattern list previously generated and that includes image identification information identifying the road image respectively corresponding to each of the road pattern data included in the road pattern list respectively in its road pattern data; and
a branch point pattern list generation device which outputs a branch point pattern list that includes road pattern data including the image identification information of the road image thus identified with respect to point identification information at the branch point and the branch point,
wherein the road data include point identification information for identifying a branch point.

9. The information generation system according to claim 7, further comprising:
an extraction device which extracts road pattern data that is not included in any one of the road pattern lists based on the plurality of road pattern data that is generated with the road pattern generation device with respect to the plurality of branch points and either one of the road pattern list thus generated with the list generation device or the road pattern list previously generated; and
a difference pattern list generation device which generates a difference pattern list including the road pattern data thus extracted.

10. An information generation process program causing a computer to function as the information generation system according to claim 1.

11. An information generation method of generating road pattern data showing a road pattern at a branch point based on road data identifying a road image that shows a road at the branch point and includes lane connection information between roads connected at the branch point, the information generation method comprising:
a step of identifying one incoming road and a plurality of outgoing roads at the branch point based on the road data;
a step of generating borderline existence information indicating whether or not a borderline defining respective lanes of the incoming road exists in correspondence with a branch between two outgoing roads adjacent to each other, based on the lane connection information between the identified incoming road and two adjacent outgoing roads;
a step of generating borderline correspondence information that indicates a relation between a borderline defining respective lanes of the incoming road and a borderline defining respective lanes of each of the outgoing roads based on the lane connection information between the incoming roads thus identified and each of the outgoing roads; and
a step of generating the road pattern data including the borderline existence information and the borderline correspondence information at the branch point.
